(19) United States
(12) Patent Application Publication
(10) Pub. No.: US 2008/0155901 A1
(43) Pub. Date: Jul. 3, 2008

(54) Window Lifter For a Motor Vehicle

(76) Inventor: Dalibor Rietdijk, Wetzlar (DE)

Correspondence Address: CHRISTIE, PARKER & HALE, LLP, PO BOX 7068, PASADENA, CA, 91109-7068, US

(21) Appl. No.: 11/884,967

(22) PCT Filed: Feb. 14, 2006
(86) PCT No.: PCT/DE06/00292

§ 371 Date: Nov. 9, 2007

(30) Foreign Application Priority Data
Feb. 24, 2005 (DE) 10 2005 008 437.0

(51) Int. Cl. E05F 15/16

(52) U.S. Cl. 49/349; 49/362

(57) ABSTRACT

A window lifter for a motor vehicle is provided. The window lifter comprising a guide rail with a rack toothing, along which a follower drive unit, which carries the pane, can be moved by means of a pinion which meshes with the rack toothing, and the follower drive unit is guided in relation to the guide rail via rolling bodies. The follower drive unit comprising a drive motor, a guide and gearing unit which holds the pinion and the at least one rolling body, and a support which holds drive motor and the guide and gearing unit.

### CROSS-REFERENCE TO A RELATED APPLICATION

This application is a National Phase Patent Application of International Patent Application Number PCT/DE2006/000292, filed on Feb. 14, 2006, which claims priority of German Patent Application Number 10 2005 008 437.0, filed on Feb. 24, 2005.

### BACKGROUND

The invention relates to a window lifter.

U.S. Pat. No. 5,806,244 shows a window lifter with two racks. The racks, which lie opposite each other, each interact with a pinion which mesh together. One of the pinions is coupled to a drive. The window pane is moved along the rack system by means of the motor. Under some circumstances, the pinion—rack system does not provide adequate precise guidance for a window pane.

DE 43 40 013 A1 discloses a window lifter, in which a guide rail has a rack toothing which interacts with a pinion in a follower drive unit. The guide rail has a bend which extends in the direction of movement of the follower drive unit and interacts in a sliding manner with guide surfaces of the follower drive unit which surrounds the guide rail in the region of the bend. The pinion is guided in this manner in relation to the rack toothing—the follower drive unit together with the pane it carries likewise being guided in this way. The pane which is to be raised and lowered is attached directly to the drive motor on the upper side of the follower drive unit.

DE 40 05 759 A1 discloses a window lifter, in which the follower drive unit is guided in relation to the guide rail, which has a toothing, via rolling bodies.

### SUMMARY

It is therefore the object of the present invention to further develop a window lifter of this type.

The invention proposes a window lifter for a motor vehicle, comprising a guide rail with a rack toothing, along which a follower drive unit, which carries the pane, can be moved by means of a pinion which meshes with the rack toothing, and in which the follower drive unit is guided in relation to the guide rail via rolling bodies, wherein the follower drive unit has the following subassemblies:
a drive motor,
a guide and gearing unit which holds the pinion and the at least one rolling body, and
a support which holds drive motor and the gearing unit.

The invention firstly provides a spatially functional delimitation of the individual subassemblies and, secondly, the integration thereof to form a follower drive unit which can be variably and optimally matched to the conditions present. The drive motor is thus preferably coupled to the gearing unit via a coupling which connects the motor shaft of the motor to the shaft of the worm of the worm gearing for the pinion. Different motors can therefore be connected in a simple manner. The worm which interacts with a worm wheel is mounted via two bearing points, which are assigned to its end regions, in the gearing. The coupling which connects the motor shaft to the worm is preferably constructed as a claw coupling in the manner of an Oldham coupling. As a result, axial and radial tolerances are compensated for.

According to one exemplary embodiment of the invention, it is provided that the worm and the worm wheel which interacts with the worm are accommodated in an encapsulated region of the guide and gearing unit. This region has permanent lubrication and is sealed in relation to the guide and gearing unit.

It is preferable for the invention if the worm gearing is not of self-locking design, and the worm wheel is connected via a wrap spring brake to the pinion which meshes with the toothing of the guide rail. A torque which is exerted on the wrap spring by the pinion expands the wrap spring in relation to a brake cup—blocking the friction locking mechanism. A torque which is exerted by the worm wheel on the wrap spring neutralizes the locking effect of the latter—the torque can be transmitted to the pinion.

The guide and gearing unit preferably has an electronic unit region which is arranged in the region of the coupling which connects the motor shaft to the worm. The electronic unit accommodated in the electronic unit region can have a Hall sensor and a ring magnet, which is fitted to the shaft of the worm, which detect the movement of the shaft. Signals for controlling the drive in terms of nip protection and the like can be derived therefrom. However, it is also possible in this electronic unit region for an electronic unit to be accommodated which, via a magnetic track on the guide rail, directly determines the absolute position of the follower drive unit and therefore of the pane to be raised and to be lowered.

The drive motor and the guide and gearing unit coupled to the drive torque are preferably integrated directly in the support which holds said units. In this case, the pane to be raised and to be lowered is arranged above the support and is therefore located essentially above the motor shaft or in the plane of the worm wheel. This results in a favorable utilization of construction space—the distance between the front side of the follower drive unit and the rear side of the guide rail can therefore be designed to be relatively level.

According to one exemplary embodiment of the invention, one section of the support which holds the drive motor and the guide and gearing unit is designed as half of the guide and gearing unit and here has the bearing points/supporting means for the rolling bodies, the pinion and the worm wheel driving the pinion. The receptacles for the bearings which carry the worm are likewise integrated in this region. Via a covering, the worm—worm wheel rolling region is separated off from the region in which rolling body and coupling are located.

It is preferably provided that the guide surface which interacts with the rolling bodies is designed as a surface which runs perpendicularly with respect to the plane of the guide rail. In particular, two guide surfaces which run parallel to each other and each interact with at least one rolling body are provided. By this means, precise guidance of the pinion in relation to the rack toothing is possible. The rolling bodies can have a convexly, concavely or conically designed running surface which interacts with the guide surface.

According to one exemplary embodiment of the invention, it is provided that the rolling body or the rolling bodies is or are each mounted about a rigid axis in relation to the follower drive unit. In order to compensate for tolerances, it can be provided in this case to keep rolling bodies with different diameters ready and to use precisely the rolling body, or the pairing of rolling bodies, in which play-free guidance of the follower drive unit arises. In a development, it can also be provided that the rolling body or the rolling bodies is or are mounted resiliently in relation to the follower drive unit. The rolling bodies are therefore adjusted in a play-free manner in relation to the guide rail.

An exemplary embodiment in which the running surface of the rolling body has a softer/harder material than the material of the guide rail results in low-wearing running of the rollers and prevents much noise from being produced. A suitably selected pairing of material also guarantees that the rolling bodies will roll—a sliding of the rollers over the guide surface is prevented.

An advantageous guidance of the pinion in relation to the rack toothing arises if at least one rolling body is arranged parallel to the plane of the pinion which meshes with the rack toothing, and the rolling body interacts with a guide surface which runs parallel to the rack toothing, and, in addition, the rolling body is coupled to the pinion which meshes with the rack toothing. The rolling guidance of the pinion results in a defined interaction of the teeth of rack and pinion.

An exemplary embodiment of the invention provides that the follower drive unit can be equipped with pinions of different diameter and, correspondingly, with rolling bodies of corresponding diameter. The selection of the pinion diameter desired transmission ratios can therefore be realized. Since, in accordance with the diameter of the pinion, the follower drive unit is then also positioned differently with respect to the guide rail, the compensation takes place by the use of correspondingly large rolling bodies. Simple assembly which can be matched to different conditions can thus be provided.

### BRIEF DESCRIPTION OF THE DRAWINGS

Furthermore, an exemplary embodiment of the invention is explained with reference to the figures, in which:

FIG. 1 shows the window lifter according to the invention with guide rail, the electronic unit region is closed by means of the cover.

FIG. 2 shows the window lifter according to the invention with guide rail, the electronic unit region is removed with the cover.

FIG. 3 shows the window lifter according to the invention with guide rail, the electronic unit region is removed with the cover.

FIG. 4 shows the window lifter according to the invention with guide rail.

FIG. 5 shows the window lifter according to the invention with guide rail.

FIG. 6 shows the drive motor together with guide and gearing unit.

FIG. 7 shows the mounting of the rolling bodies of the bearing plate of the guide and gearing unit.

FIG. 8 shows the bearing plate of the guide and gearing unit, with pinion removed.

FIG. 9 shows the bearing plate of the guide and gearing unit, with pinion removed.

FIG. 10 shows the bearing plate of the guide and gearing unit, with pinion removed.

FIG. 11 shows the pinion and the connection thereof to the worm wheel.

FIG. 12 shows the pinion and the connection thereof to the worm wheel.

FIG. 13 shows the pinion and the connection thereof to the worm wheel.

FIG. 14 shows the pinion and the connection thereof to the worm wheel.

FIG. 15 shows the window lifter and components according to the invention in an exploded illustration.

FIG. 16 shows the window lifter and components according to the invention in an exploded illustration.

FIG. 17 shows the window lifter and components according to the invention in an exploded illustration.

FIG. 18 shows the window lifter and components according to the invention in an exploded illustration.

FIG. 19 shows a rear view of a follower drive unit of the window lifter from FIGS. 1 to 5.

### DETAILED DESCRIPTION

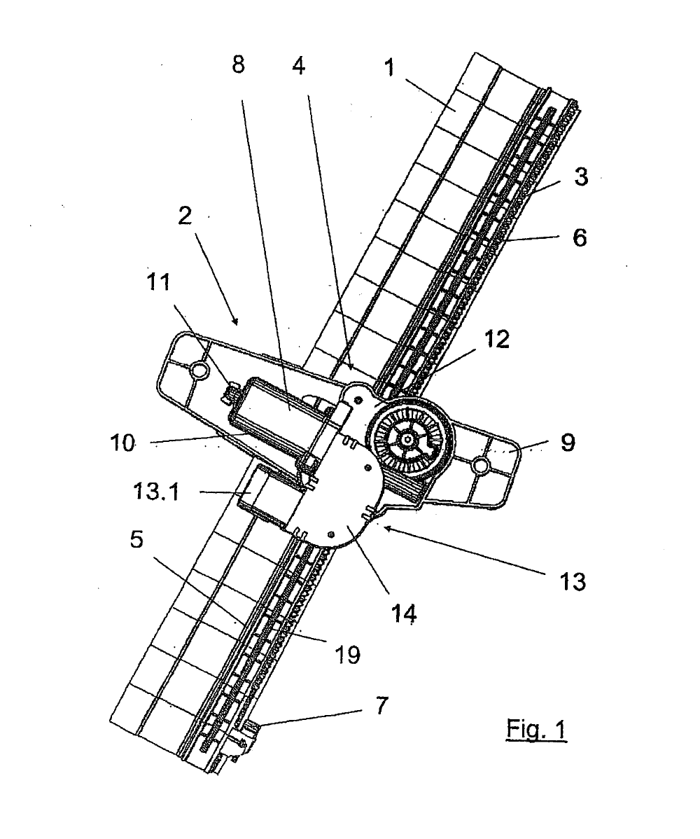

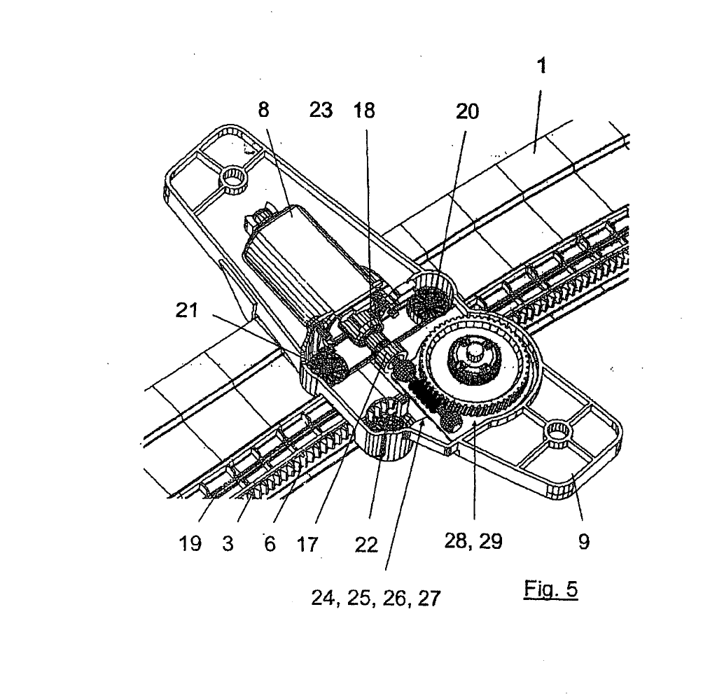

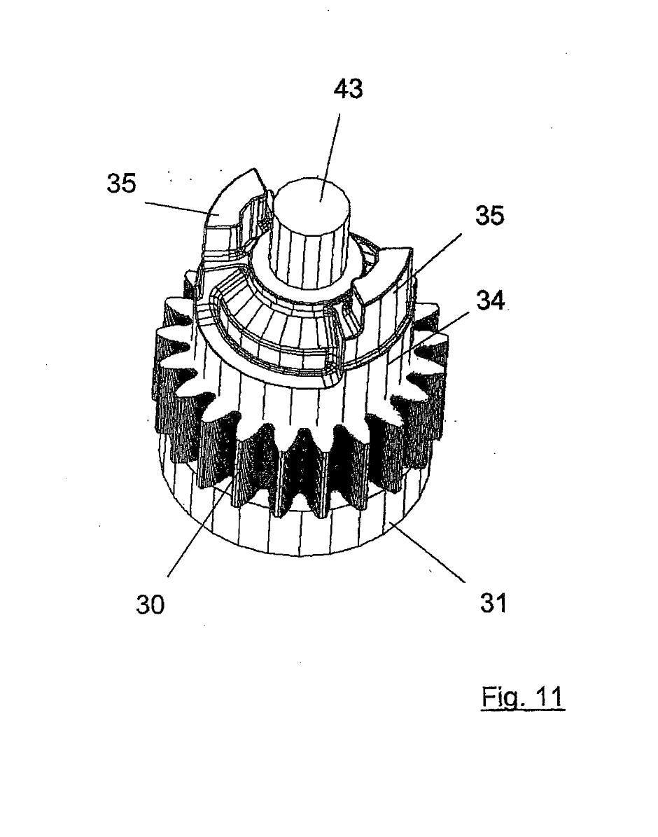

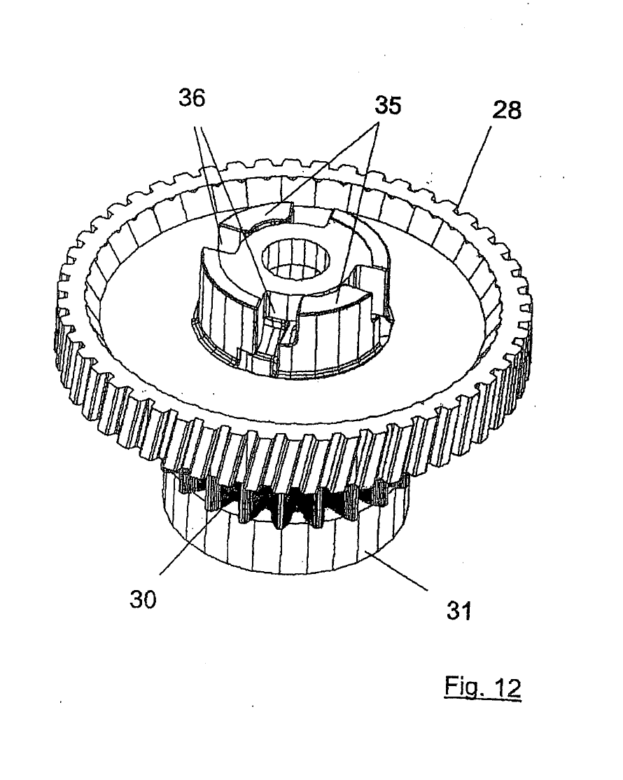

FIGS. 1-5 show a guide rail 1 which is preferably manufactured from plastic and along which a follower drive unit 2 can be moved. The guide rail 1 has a toothing 3 which interacts with a pinion 30 (not illustrated here) in a guide and gearing unit 4 of the follower drive unit 2. Furthermore, two guide surfaces 5, 6 are integrally formed on the guide rail 1, one of said guide surfaces 6 running parallel to the toothing 3. In this case, the guide surface 6 lies precisely on the pitch circle of the pinion 30 which interacts with the toothing 3 (FIGS. 11, 12). The lower end of the guide rail 1 is assigned an end stop 7 with an elastic element.

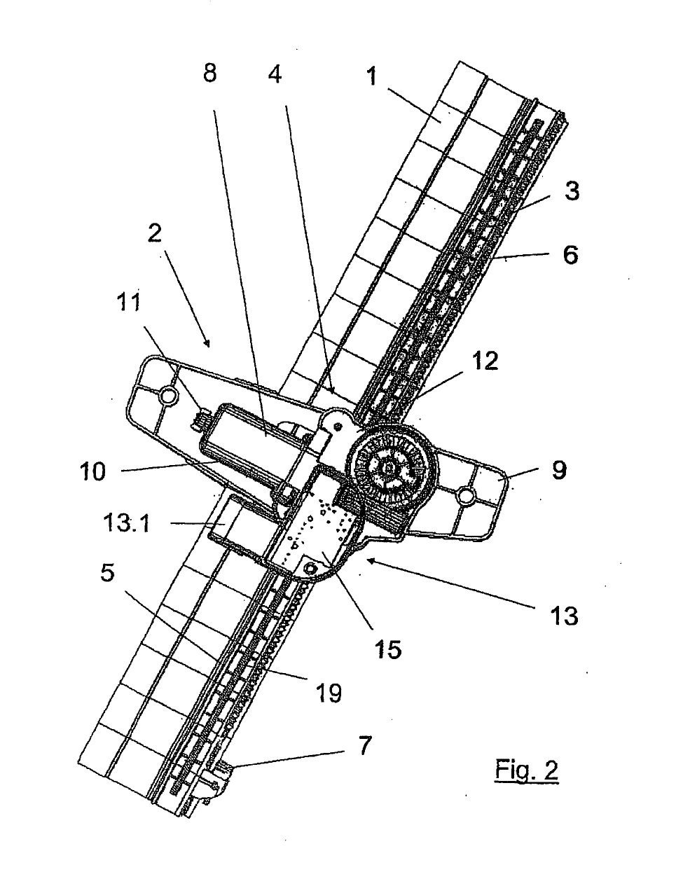

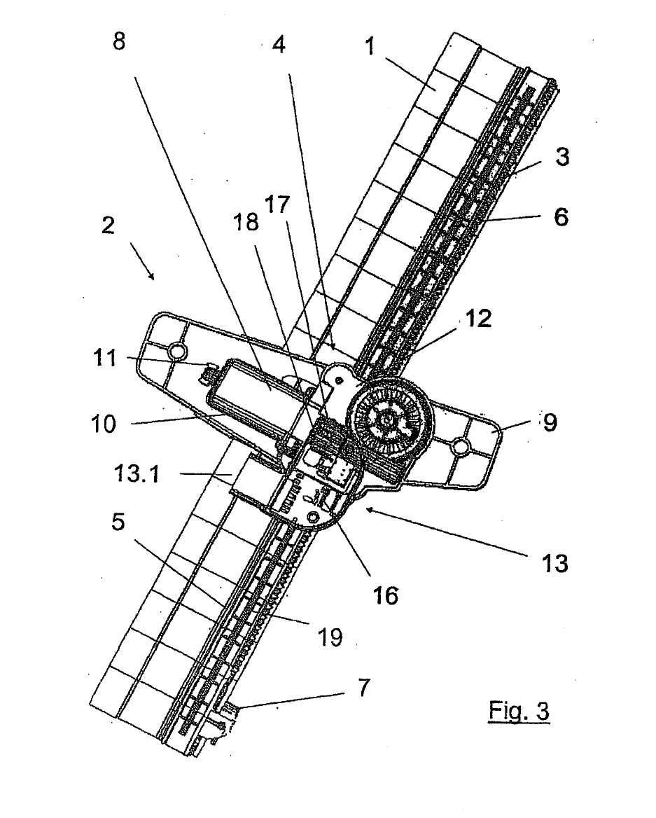

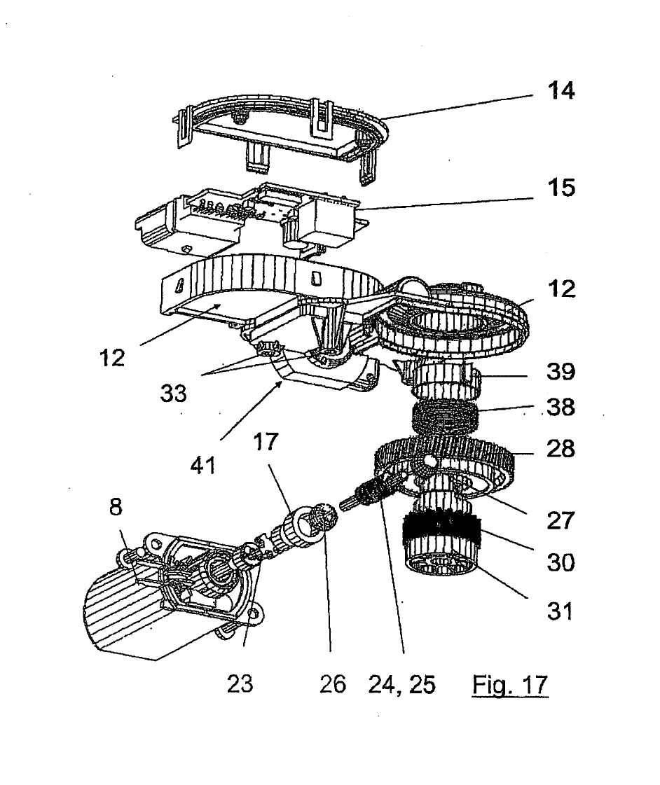

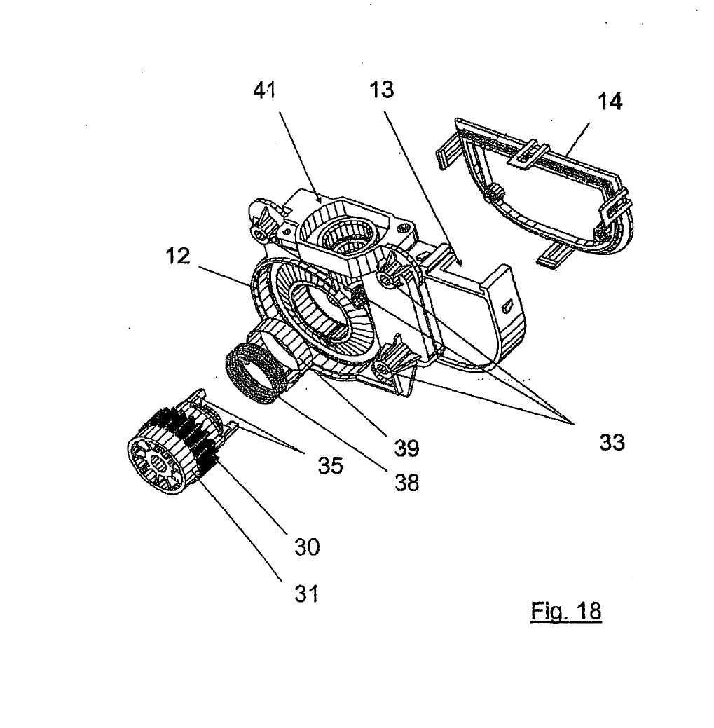

Drive motor 8 and the guide and gearing unit 4 are held by a support 9 designed in the form of a molded part. The rotor housing of the drive motor 8 (pole cup) is embedded here in an opening 10, which is designed in accordance with the external dimensions of said rotor housing, of the support 9. That end of the drive motor 8 which holds the dome bearing of the motor shaft 18 is fixed on the support 9 via a latching receptacle 11. The bearing plate 12, which can be inserted into the support 9, of the guide and gearing unit 4 has a receptacle for an electronic unit region 13 with a plug-in connection 13.1, which region is closed by a cover 14 together with sealing via latching elements. Instead of a plug-in connection 13.1, a ribbon cable or a ribbon conductor connected directly to the printed circuit board 15 can also be led out here. FIG. 1 shows the electronic unit region 13 closed by means of the cover 14, FIGS. 2 and 3 show the electronic unit region 13 with the cover 14 removed. A printed circuit board 15 with an electronic unit 16 is accommodated in said electronic unit region 13, the upper printed circuit board 15 having been removed and thus only the components of the electronic unit 16 being illustrated in FIG. 3. By means of the electronic unit 16 accommodated in the electronic unit region 13, the movement of the motor shaft 18 is detected via a ring magnet 17, explained further below—furthermore, a second signal transmitter system interacts with a magnetic signal track 19 in order to detect the absolute position of the follower drive unit 2. The cover 14 of the electronic unit region 13 has a peripheral seal which interacts with the inner wall of the receptacle of the electronic unit region 13 (FIGS. 17, 18).

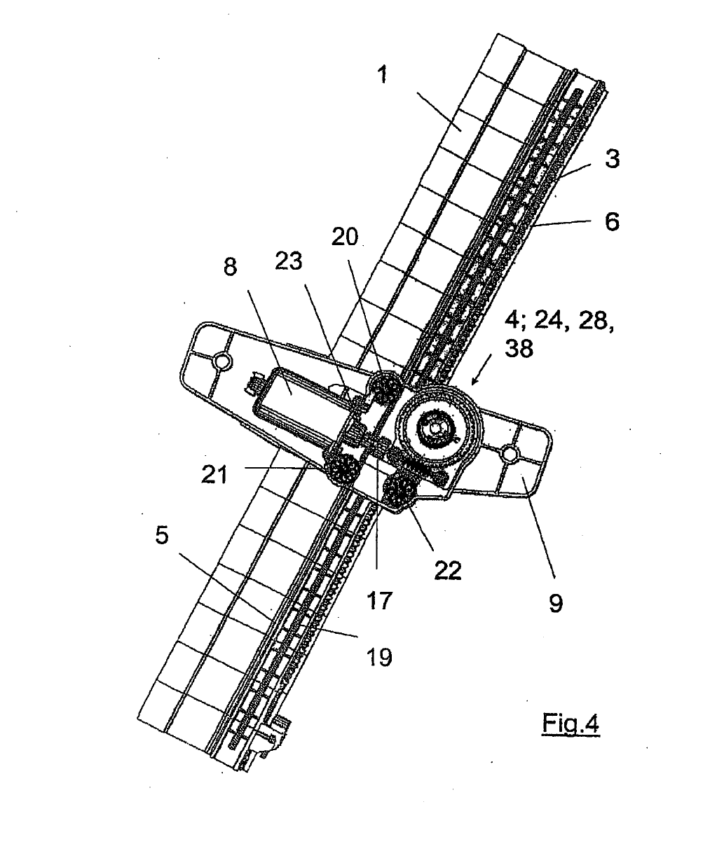

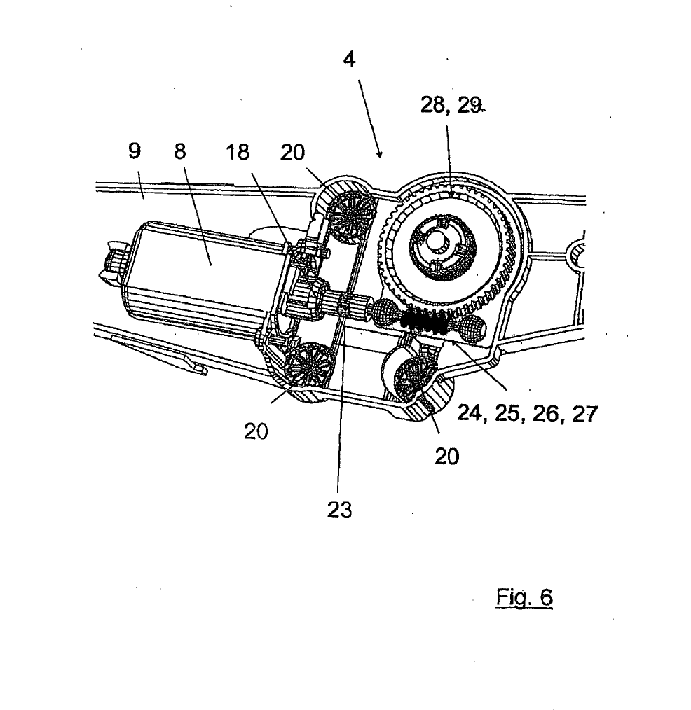

The receptacle of the electronic unit region 13 is located on a bearing plate 12 of the guide and gearing unit 4. Said bearing plate 12 can be removed from the support 9, as illustrated in FIGS. 4, 5 and 6. The guide and gearing unit 4 of the support 9 holds three individual rolling bodies 20, 21, 22 which interact with the two guide surfaces 5, 6 of the guide rail 1. The motor shaft 18 of the drive motor 8 is coupled to a worm 24—the shaft 25 thereof—via a claw coupling 23 with an elastic intermediate layer. The elastic intermediate layer between the two claws of the coupling 23 secures motor shaft 18 and the shaft 25 of the worm 24 in place. Positional tolerances of the two shafts 18, 25 are therefore compensated for in a manner free from play. A ring magnet 17 is located on that part of the coupling 23 which is assigned to the shaft 25 and interacts with a signal transmitter of an electronic unit (not illustrated here).

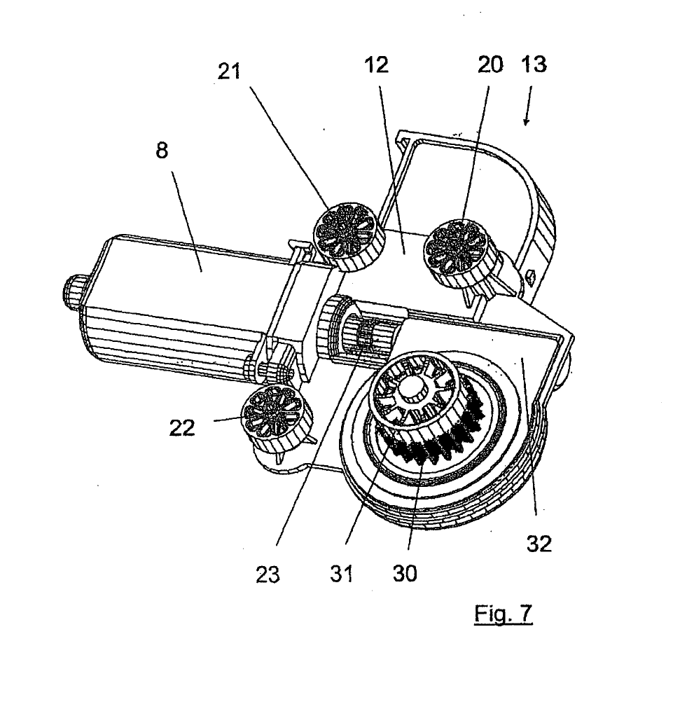

The two ends of the worm 24—the shaft 25—are held in the guide and gearing unit 4 (the bearing plate 12) in a manner supported rotatably and axially via a respective bearing 26, 27. A worm wheel 28 meshes with the worm 24, the worm 24—worm wheel 28 system not being of self-locking design so as to obtain good efficiency. In order to absorb forces exerted on the follower drive unit 2 (for example the weight of the pane), the worm 24 interacts via a wrap spring 29 with the pinion 30, which is illustrated in FIG. 7. The pinion 30 has parallel a rolling body surface 31 which interacts with the guide surface 6 running next to the toothing 3 (FIGS. 1-5). The rolling body 20 also interacts with said guide surface 6 (FIG. 7).

FIG. 7 shows the mounting of the rolling bodies 20, 21, 22 on the bearing plate 12 of the guide and gearing unit 4. The mounting takes place via integrally formed bearings 33. The pinion 30 and the rolling body surface 31, which is fitted and coupled parallel to the pinion 30, are located on the side, which faces the guide rail 1, of a sealing element 32, which is manufactured from elastic material, of the bearing plate 12. Below said sealing element 32, the worm wheel 28 together with the shaft 25 of the worm 24, which shaft is mounted at both ends in the bearings 26, 27, is located in a filling of grease. Furthermore, the elastic sealing element 32 also fixes the bearings 26, 27 in a manner free from play in their correspondingly shaped receptacles of the bearing plate 12, and brings about a noise reduction.

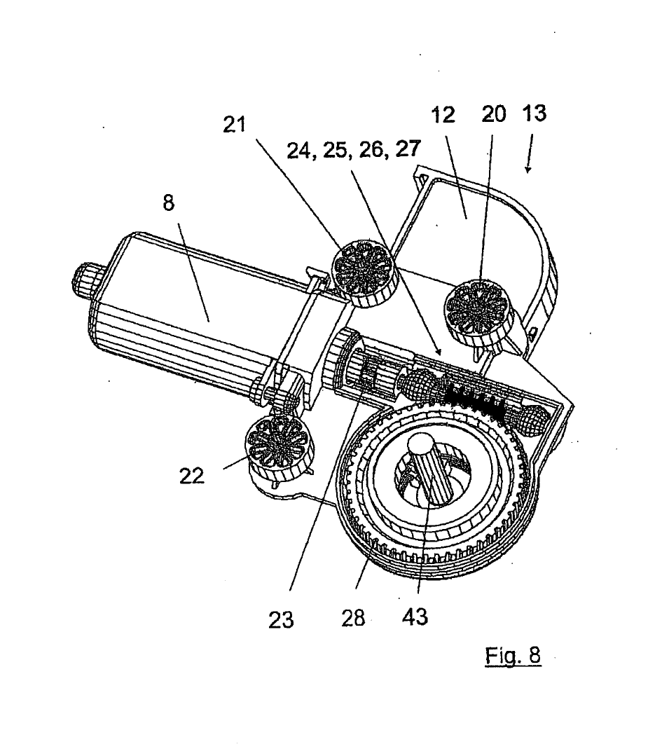

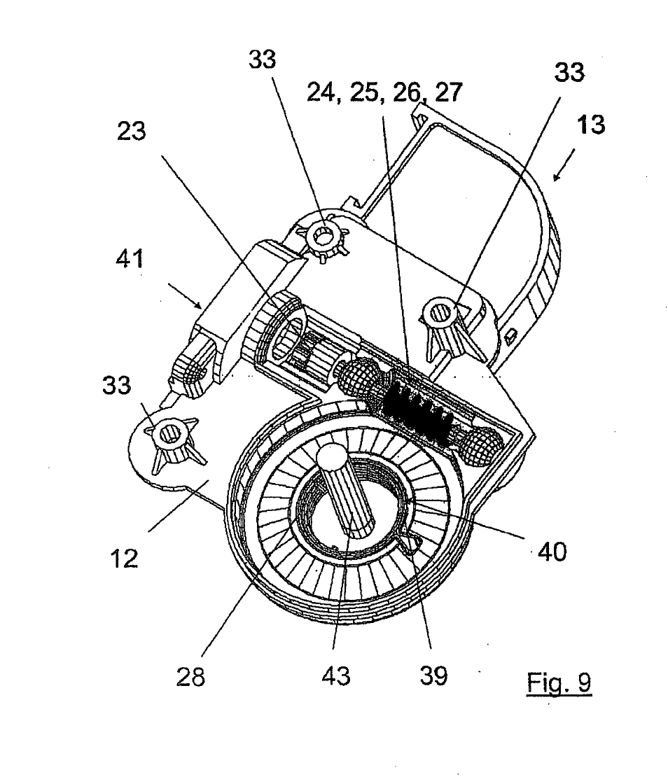

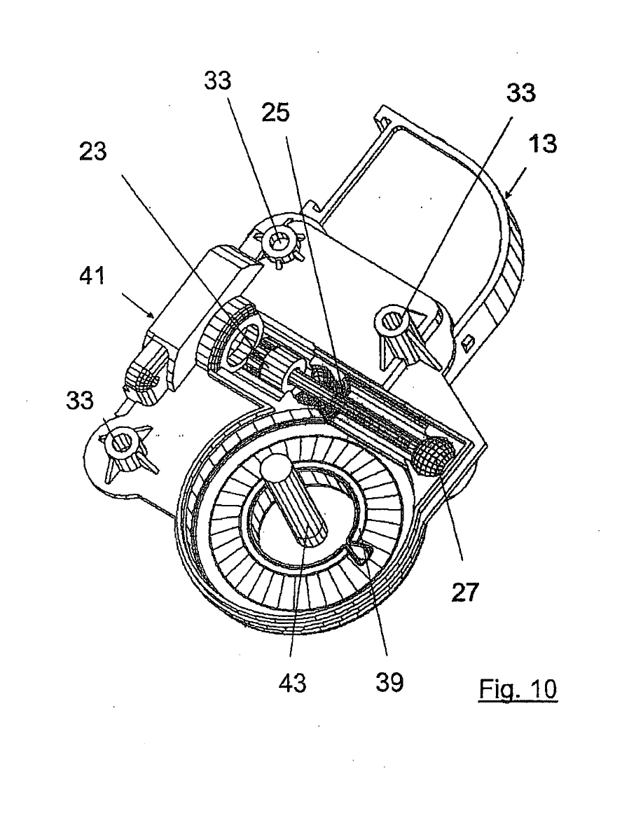

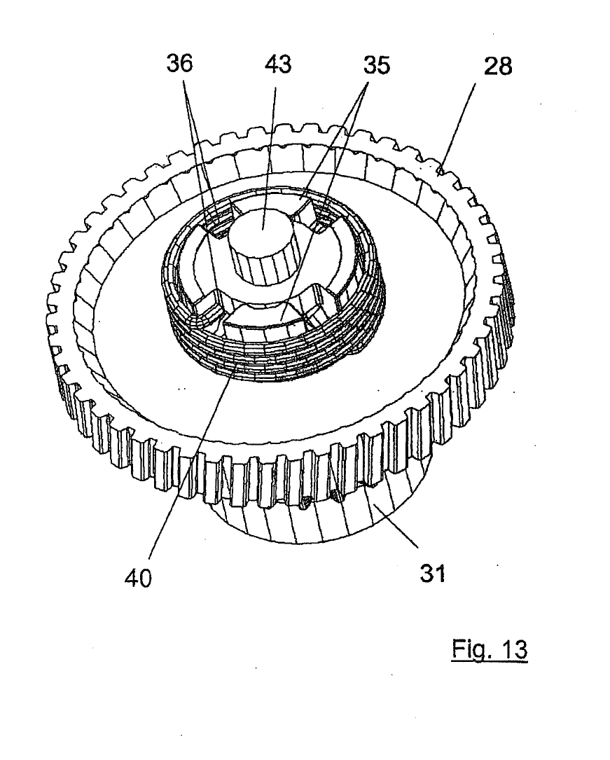

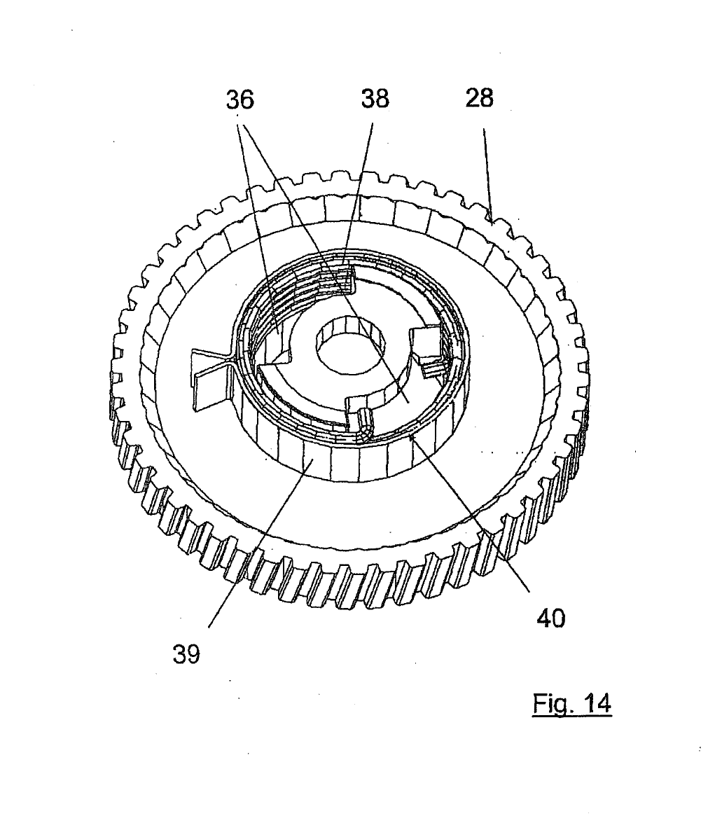

FIG. 8 shows the bearing plate 12 of the guide and gearing unit 4, with pinion 30 removed, and of the sealing element 32. The pinion 30, which is not illustrated in FIGS. 8, 9 and 10, together with rolling body surface 31 is mounted rotatably on a peg 43 of the bearing plate 12 of the guide and gearing unit 4. In this case, said peg 43 reaches through an opening of the worm wheel 28, into which the stem 34 of the pinion 30 is rotatably inserted (FIGS. 11 and 12). On the end side, the pinion 30 has two claws 35 which dip into two recesses 36 of the worm wheel 28 in the manner of a claw coupling. One claw 35 of the pinion 30 interacts in a recess 36 of the worm wheel 28 with the bent ends of a wrap spring 38 which is seated on a collar 37 of the worm wheel 28 (FIG. 13). Pinion 30, the rolling body surface 31, the collar 37 and the claws 35 form a unit which is preferably composed of a single piece. The wrap spring 38 interacts via its outer circumference with a metal strip (FIG. 14) which forms the brake cup 39 and, for its part, is embedded in a correspondingly shaped receptacle of the bearing plate 12 of the guide and gearing unit 4 (FIG. 10). The metal strip of the brake cup has a small thickness, and therefore it can fit precisely and snugly against the cylindrical receptacle in the bearing plate 12. Wrap spring 38 and metal strip of the brake cup 39 thereby form the wrap spring brake 40 of the follower drive unit.

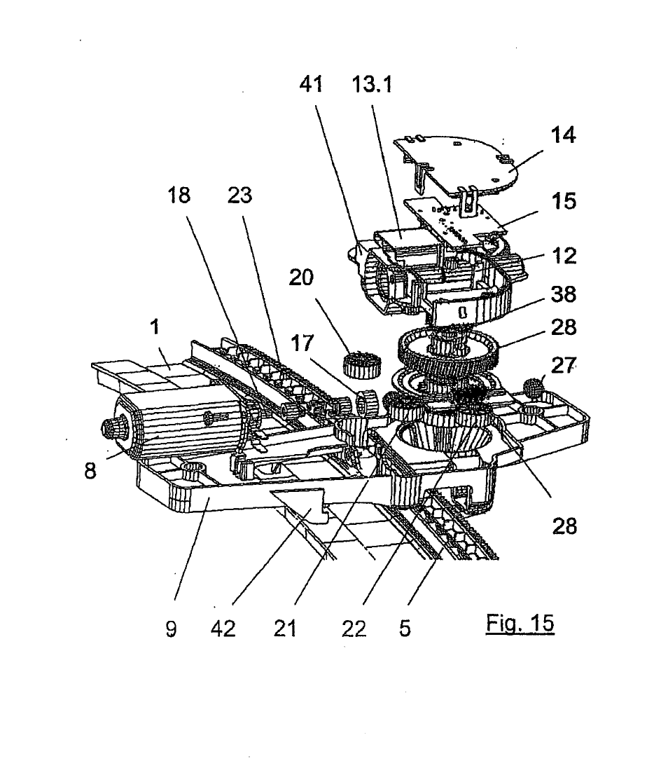

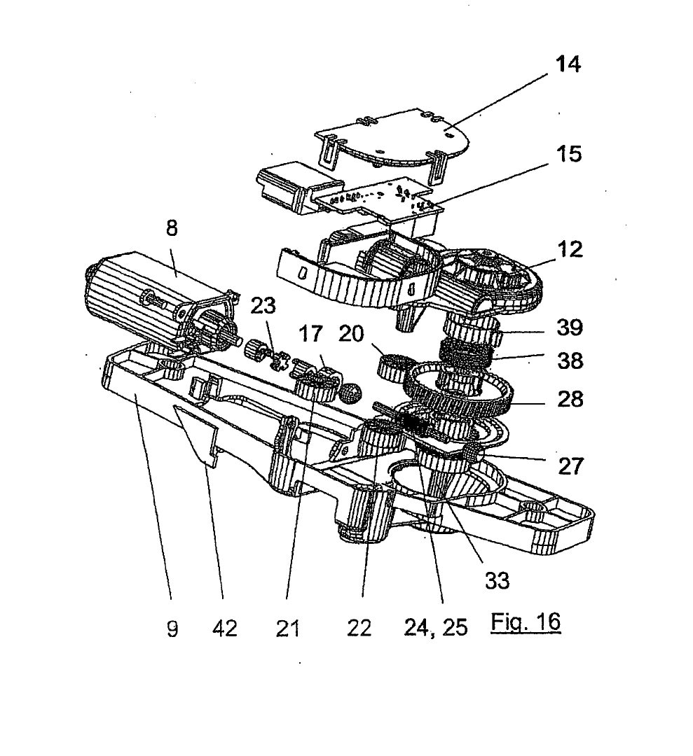

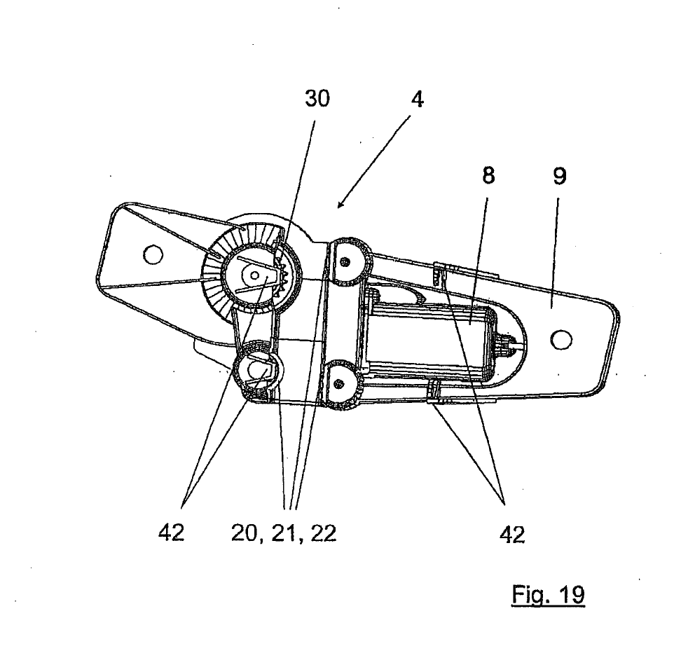

FIGS. 15-18 show, in an exploded illustration, the follower drive unit 2 with and without guide rail 1. The bearing plate 12 has a flange region 41 for holding the drive motor 8. FIG. 18 illustrates the components pinion 30, wrap spring 38, brake cup 39, bearing plate 12 and the cover 14 of the electronic unit region 13. FIGS. 15 and 16 show that, on the side facing the guide rail 1, the support 4 has a respective rear-acting rail grip 42 in the form of a region designed as a hook. The follower drive unit 2 is therefore fixed perpendicularly with respect to the plane of the guide rail 1. In the rear view of the follower drive unit 2 according to FIG. 19, the rear-acting rail grips 42 are reproduced—the latter are located in the region of the recesses in the support for the rolling body 20 and the pinion 30 and lying opposite in the region of the drive motor 8. The support 9, the bearing cover 12, the covering 32 of worm 24 and worm wheel 28 and the cover 14 of the electronic unit region are manufactured from plastic.

1-30. (canceled)

31. A window lifter for a motor vehicle, comprising a guide rail with a rack toothing, along which a follower drive unit, which carries the pane, can be moved by means of a pinion which meshes with the rack toothing, and the follower drive unit is guided in relation to the guide rail via rolling bodies, wherein the follower drive unit has the following subassemblies:
a drive motor,
a guide and gearing unit which holds the pinion and the at least one rolling body, and
a support which holds drive motor and the guide and gearing unit.

32. The window lifter of claim 31, wherein the guide surface which interacts with the rolling body is designed as a surface which runs perpendicularly with respect to the plane of the guide rail.

33. The window lifter of claim 31 or 32, wherein two guide surfaces which run parallel to each other and each interact with a rolling body are provided.

34. The window lifter of claim 31, wherein the rolling body has a cylindrical or convexly, concavely or conically designed running surface which interacts with the guide surface.

35. The window lifter of claim 31, wherein the rolling body is mounted resiliently in relation to the follower drive unit.

36. The window lifter of claim 31, wherein the running surface of the rolling body has a different hardness from the material of the guide rail.

37. The window lifter of claim 31, wherein the rolling body or the rolling bodies lie in the plane of the pinion which meshes with the rack toothing.

38. The window lifter of claim 31, wherein at least one rolling body is arranged parallel to the plane of the pinion which meshes with the rack toothing.

39. The window lifter of claim 38, wherein the rolling body interacts with a guide surface which runs parallel to the rack toothing.

40. The window lifter of claim 39, wherein a rolling body is coupled to the pinion which meshes with the rack toothing, and, as diameter, has that of the pitch circle of the pinion.

41. The window lifter of claim 31, wherein the follower drive unit can be equipped with pinions of different diameter and, correspondingly, with rolling bodies of corresponding diameter.

42. The window lifter of claim 31, wherein the guide and gearing unit is designed as a bearing plate which mounts the at least one rolling body together with the pinion.

43. The window lifter of claim 31, wherein the guide and gearing unit has an electronic unit region.

44. The window lifter of claim 43, wherein the electronic unit region can be closed by means of a cover and latching connection.

45. The window lifter of claim 43, wherein the electronic unit region has an electronic unit which detects the movement of the motor shaft.

46. The window lifter of claim 43, wherein the electronic unit region has an electronic unit which detects the position of the follower drive unit with respect to the guide rail.

47. The window lifter of claim 46, wherein the electronic unit interacts with a signal track on the guide rail.

48. The window lifter of claim 31, wherein the guide and gearing unit has a worm wheel which is coupled to the pinion, and a worm which meshes with the worm and is driven by the drive motor.

49. The window lifter of claim 48, wherein the drive motor is coupled to the shaft of the worm via a coupling.

50. The window lifter of claim 31, wherein the guide and gearing unit has a flange region which holds the drive motor.

51. The window lifter of claim 48, wherein worm and worm wheel are arranged in a region of the guide and gearing unit that is encapsulated by means of a sealing element.

52. The window lifter of claim 48, wherein the worm-worm wheel system is not of self-locking design and the drive pinion is assigned a brake.

53. The window lifter of claim 52, wherein the brake is designed as a wrap spring brake.

54. The window lifter of claim 53, wherein wrap spring brake has a brake cup which is composed of a metal strip and can be inserted into a corresponding region of the bearing plate.

55. The window lifter of claim 31, wherein the support has an opening which holds the housing of the drive motor.

56. The window lifter of claim 55, wherein the drive motor is fixed on the support by means of a latching connection.

57. The window lifter of claim 31, wherein the follower drive unit has rear-acting rail grips which interact with the guide rail.

58. The window lifter of claim 49, wherein the coupling is designed as a claw coupling.

59. The window lifter of claim 58, wherein an element which is spring-elastic in the axial direction is arranged between the claws of the coupling.

60. The window lifter of claim 54, wherein the metal strip of the brake cup has a small thickness.
